(19) United States
(12) Patent Application Publication
(10) Pub. No.: US 2026/0029226 A1
(43) Pub. Date: Jan. 29, 2026

(54) SEMICONDUCTOR MEASURING DEVICE AND METHOD

(71) Applicant: SAMSUNG ELECTRONICS CO., LTD., Suwon-si (KR)

(72) Inventors: Sung-Il CHOI, Suwon-si (KR); Jaeho KIM, Suwon-si (KR); Seong-Eun KANG, Suwon-si (KR); Kyungbeom KIM, Suwon-si (KR); Mira PARK, Suwon-si (KR); Sung Hong PARK, Suwon-si (KR); YOUNGHOON SOHN, Suwon-si (KR); Younsub LEE, Suwon-si (KR)

(73) Assignee: SAMSUNG ELECTRONICS CO., LTD., Suwon-si (KR)

(21) Appl. No.: 19/089,758

(22) Filed: Mar. 25, 2025

(30) Foreign Application Priority Data
Jul. 23, 2024 (KR) 10-2024-0097538

(51) Int. Cl. G01B 11/06; G01N 21/21

(52) U.S. Cl. CPC G01B 11/06; G01N 21/21; G01B 2210/56

(57) ABSTRACT

A semiconductor measuring device may include: a light source configured to output light with a specified wavelength toward a measurement target; an aperture on a light path along which reflected light reflected from the measurement target travels and comprising a first part and a second part that are spaced apart; at least one sensor configured to detect positions of the first part and the second part; and a controller electrically connected to the aperture and the at least one sensor, wherein the controller is configured to: determine a type of the measurement target based on type information; and control a position of at least one of the first part and the second part so that the first part and the second part have a gap that is a first gap corresponding to a first type based on the measurement target corresponding to the first type.

### CROSS-REFERENCE TO RELATED APPLICATION(S)

This U.S. non-provisional application claims priority under 35 USC § 119 to Korean Patent Application No. 10-2024-0097538, filed on Jul. 23, 2024, in the Korean Intellectual Property Office, the disclosure of which is herein incorporated by reference in its entirety.

### BACKGROUND

### 1. Field

This disclosure relates to a semiconductor measuring device and method.

### 2. Description of Related Art

Semiconductor elements are manufactured using a wafer and manufactured through several hundreds of manufacturing processes. Therefore, after performing several manufacturing processes of the semiconductor elements on the wafer, the results of the manufacturing process need to be inspected and measured in a short time.

An electron microscope, a spectroscopy ellipsometry (SE), a spectroscopic reflectometer (SR), etc. are used to measure physical quantities such as a pattern structure of the semiconductor element or a thickness of a thin film.

Among them, the SE and the SR may measure the pattern structure, the thickness of the thin film, etc. by comparing spectral changes of polarization components from a sample with a theoretical spectrum acquired through an optical simulation.

Recently, as the demand for production of various semiconductor elements such as a vertical-NAND (V-NAND), a dynamic random access memory (DRAM), and logic circuits has increased, the demand for semiconductor measuring devices capable of measuring different thicknesses has been increasing.

### SUMMARY

One or more embodiments of the present disclosure are directed to providing a semiconductor measuring device capable of accurately measuring thicknesses of different measurement targets without replacing any component.

According to one or more example embodiments, a semiconductor measuring device may include: a light source configured to output light with a specified wavelength toward a measurement target; an aperture on a light path along which reflected light reflected from the measurement target travels and comprising a first part and a second part that are spaced apart; at least one sensor configured to detect positions of the first part and the second part; and a controller electrically connected to the aperture and the at least one sensor, wherein the controller is configured to: determine a type of the measurement target based on type information; control a position of at least one of the first part and the second part so that the first part and the second part have a gap that is a first gap corresponding to a first type based on the measurement target corresponding to the first type; and determine whether the first part and the second part have the first gap based on the positions of the first part and the second part that are acquired from the at least one sensor.

The semiconductor measuring may further include: a computing device configured to calculate a thickness of the measurement target based on polarization information about the reflected light passing through the aperture. The controller may be further configured to measure the thickness of the measurement target through the computing device based on the first part and the second part having the first gap.

The controller may be further configured to output error data based on the gap between the first part and the second part differing from the first gap.

The controller may be further configured to control the position of at least one of the first part and the second part so that the first part and the second part have a second gap corresponding to a second type based on the measurement target corresponding to the second type distinguished from the first type, and the second gap may be smaller than the first gap.

The controller may be further configured to: based on the measurement target corresponding to the first type, move the first part in a first direction and move the second part in a second direction opposite to the first direction.

The first part may include a first surface, and the second part may include a second surface. The at least one sensor may include: a first sensor between the first surface and the computing device; and a second sensor between the second surface and the computing device. The controller may be further configured to determine whether the first part and the second part have the first gap by using at least one of first position data of the first part measured through the first sensor and second position data of the second part measured through the second sensor.

The first part may include a plurality of recesses having different depths on the first surface. The first sensor may be configured to detect a direction in which the first part moves by control of the controller based on a depth measured from one of the plurality of recesses. The controller may be further configured to determine whether the first part and the second part have the first gap based on the direction in which the first part moves.

The first sensor may be attached to the first surface and the second sensor is attached to the second surface, and the first sensor may be configured to detect a change in the gap between the first part and the second part based on a time when a signal is output to the second sensor and the output signal is received by being reflected from the second sensor.

The semiconductor measuring device further may include: an internal storage device configured to store the gap between the first part and the second part, which corresponds to the type of the measurement target. The gap between the first part and the second part, which corresponds to the type of the measurement target, may be stored as a lookup table.

The semiconductor measuring device further may include: a polarizer configured to control a polarization direction of the light output from the light source; and an analyzer configured to acquire the polarization information about the reflected light by acquiring the reflected light reflected from the measurement target.

According to one or more example embodiments, a method for measuring a thickness of a measurement target, may include: determining a type of the measurement target based on type information of the measurement target; controlling a position of at least one of a first part and a second part so that the first part and the second part that are in an aperture have a gap that is a first gap corresponding to a first type based on the measurement target corresponding to the first type; and determining whether the first part and the second part have the first gap based on position data of the first part and the second part acquired from at least one sensor.

The method further may include: measuring a thickness of the measurement target based on polarization information about reflected light output from a light source, reflected from the measurement target, and passing through the aperture, based on the first part and the second part having the first gap.

The method further may include: outputting error data based on the gap between the first part and the second part differing from the first gap.

The method further may include: controlling the position of at least one of the first part and the second part so that the first part and the second part have a second gap corresponding to a second type based on the measurement target corresponding to the second type distinguished from the first type. The second gap may be larger than the first gap.

The method further may include: outputting a signal toward at least one of the first part and the second part using the at least one sensor; and detecting the position data of the first part and the second part based on a time when the output signal is received by being reflected from the at least one of the first part and the second part.

According to one or more example embodiments, a semiconductor measuring device may include: a light source configured to output light toward a measurement target; an aperture on a light path along which reflected light from the measurement target travels and comprising a first part and a second part that are spaced apart to form a pinhole; at least one sensor configured to detect a size of the pinhole; and a controller connected to the aperture and the at least one sensor, wherein the controller is configured to: control positions of the first part and the second part so that the pinhole has the size corresponding to a type of the measurement target based on the type of the measurement target; and determine whether the pinhole has the size corresponding to the type of the measurement target based on data associated with the size of the pinhole acquired from the at least one sensor.

The semiconductor measuring device further may include: a computing device configured to calculate a thickness of the measurement target based on polarization information about the reflected light passing through the aperture. The controller may be further configured to measure the thickness of the measurement target using the computing device based on the pinhole having the size corresponding to the type of the measurement target.

The controller may be further configured to output error data based on the pinhole not having the size corresponding to the type of the measurement target.

The first part may include a first surface, and the second part may include a second surface. The at least one sensor may include: a first sensor between the first surface and the computing device, the first sensor being configured to measure first position data of the first part; and a second sensor between the second surface and the computing device, the second sensor being configured to measure second position data of the second part. The controller may be further configured to determine whether the pinhole formed by the first part and the second part has the size corresponding to the type of the measurement target using at least one of the first position data and the second position data.

The semiconductor measuring device further may include: a polarizer configured to control a polarization direction of the light output from the light source; and an analyzer configured to acquire the polarization information about the reflected light by acquiring the reflected light reflected from the measurement target.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 shows a configuration of a semiconductor measuring device according to one or more embodiments of the present disclosure;

FIG. 2A shows a configuration in which a controller according to one or more embodiments controls a first part and a second part so that the first part and the second part have a first gap;

FIG. 2B shows a configuration in which the controller according to one or more embodiments controls the first part and the second part so that the first part and the second part have a second gap;

FIG. 3A shows a configuration in which the controller according to one or more embodiments controls the first part so that the first part and the second part have the first gap;

FIG. 3B shows a configuration in which the controller according to one or more embodiments controls the second part so that the first part and the second part have the first gap;

FIG. 4A shows a configuration in which the controller according to one or more embodiments controls the first part so that the first part and the second part have the second gap;

FIG. 4B shows a configuration in which the controller according to one or more embodiments controls the second part so that the first part and the second part have the second gap;

FIG. 5A shows a configuration in which at least one sensor according to one or more embodiments determines whether the first part and the second part have the first gap using recesses formed in each of the first part and the second part;

FIG. 5B shows a configuration in which at least one sensor according to one or more embodiments determines whether the first part and the second part have the second gap using recesses formed in each of the first part and the second part;

FIG. 6A shows a configuration in which the controller according to one or more embodiments determines whether the first part and the second part have the first gap using a first sensor and a second sensor that are attached to each of the portions;

FIG. 6B shows a configuration in which the controller according to one or more embodiments determines whether the first part and the second part have the second gap using the first sensor and the second sensor that are attached to each of the portions;

FIG. 7 shows a semiconductor measuring device further including a computing device for calculating a thickness of a measurement target using polarization information about reflected light according to one or more embodiments;

FIG. 8 shows a semiconductor measuring device further including a polarizer and an analyzer according to one or more embodiments;

FIG. 9 is a flow chart showing a method for measuring a thickness of a measurement target by the semiconductor measuring device according to one or more embodiments; and

FIG. 10 is a flow chart showing a method for measuring the thickness of the measurement target based on whether the first part and the second part have the first gap according to one or more embodiments.

### DETAILED DESCRIPTION

Hereinafter, embodiments of the present disclosure will be described clearly and in detail so that those skilled in the art can easily practice the present disclosure.

In the present disclosure, the terms “first,” “second,” and the like may be used to describe various components, without regard to order and/or importance, used merely to distinguish one component from another, and do not limit the order or importance of the components.

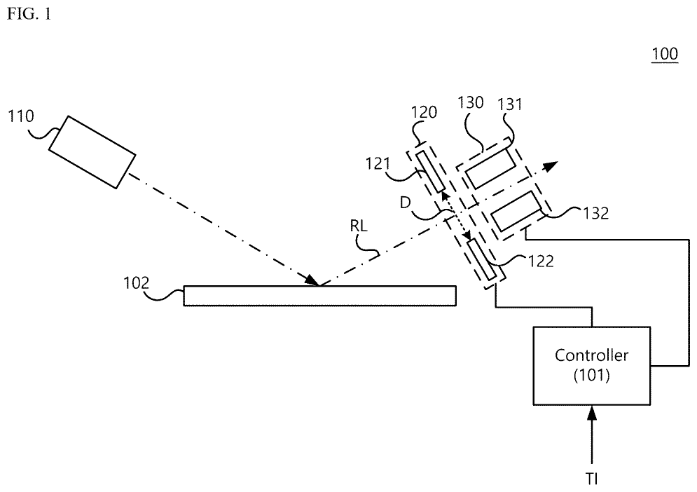

FIG. 1 shows a configuration of a semiconductor measuring device according to one or more embodiments of the present disclosure.

Referring to FIG. 1, the semiconductor measuring device 100 according to one or more embodiments may include a light source 110, an aperture 120, at least one sensor 130, and a controller 101.

According to one or more embodiments, the semiconductor measuring device 100 may include a light source 110 that outputs light traveling toward a measurement target 102. More specifically, the light source 110 may output light traveling toward the measurement target with a specified wavelength.

Here, for example, the light source 110 may be referred to as a multi-color light output device that outputs a multi-wavelength beam (or multi-color light) including different wavelengths. However, in another example, the light source 110 may be referred to as a single-wavelength laser device that outputs a single-wavelength beam (or monochromatic light).

In addition, the semiconductor measuring device 100 may include an aperture 120 disposed on a light path along which a reflected light RL travels. More specifically, the semiconductor measuring device 100 may include an aperture 120 disposed on a light path along which the reflected light RL reflected from the measurement target 102 travels.

According to one or more embodiments, the aperture 120 may include a first part 121 and a second part 122 that are spaced apart from each other. More specifically, the aperture 120 may include the first part 121 and the second part 122 that are formed to be spaced a predetermined gap D from each other.

According to one or more embodiments, the reflected light RL may pass through a space between the first part 121 and the second part 122. Here, the reflected light RL may be referred to as light that is output from the light source 110 and reflected from the measurement target 102.

That is, the aperture 120 may allow at least some of the reflected light RL to pass through the space between the first part 121 and the second part 122.

Therefore, the space (or distance) between the first part 121 and the second part 122 may be referred to as a pinhole through which the reflected light RL passes.

In addition, the semiconductor measuring device 100 may include at least one sensor 130 disposed adjacent to the aperture 120.

According to one or more embodiments, the at least one sensor 130 may detect the gap between the first part 121 and the second part 122. More specifically, the at least one sensor 130 may detect a position of each of the first part 121 and the second part 122.

The at least one sensor 130 may include a first sensor 131 that detects first position data of the first part 121. In addition, the at least one sensor 130 may include a second sensor 132 that detects second position data of the second part 122.

Here, for example, the first position data may include at least some of a moving direction, moving distance, and current position of the first part 121. In addition, for example, the second position data may include at least some of a moving direction, moving distance, and current position of the second part 122.

The first sensor 131 according to one or more embodiments may be disposed to be adjacent to the first part 121. In addition, the second sensor 132 may be disposed to be adjacent to the second part 122.

Furthermore, the at least one sensor 130 may detect the gap D between the first part 121 and the second part 122 based on the position data of the first part 121 and/or the second part 122.

For example, when the at least one sensor 130 detects that the first part 121 moves in a direction away from the second part 122, the at least one sensor 130 may determine that the gap D between the first part 121 and the second part 122 increases.

In addition, the semiconductor measuring device 100 may include a controller 101 electrically connected to the aperture 120 and the at least one sensor 130.

The controller 101 may execute, for example, a software (or a program) to control at least one of other components (e.g., the aperture 120, and/or the at least one sensor 130) of the semiconductor measuring device 100 and perform various data processing or calculations. The controller 101 may include a central processing unit, a microprocessor, etc. and may control the overall operation of the semiconductor measuring device 100. Therefore, it can be understood that the operation performed by the semiconductor measuring device 100 is performed under the control of the controller 101.

According to one or more embodiments, the controller 101 may include an algorithm for controlling the aperture 120. For example, the algorithm may be software codes programmed inside the controller 101. For another example, the algorithm may be hard codes hard-coded inside the controller 101, but is not limited to thereto.

The controller 101 may control at least one of the first part 121 and the second part 122 included in the aperture 120 according to the algorithm.

More specifically, the controller 101 may change a position of at least one of the first part 121 and the second part 122. Therefore, the controller 101 may control the gap D between the first part 121 and the second part 122.

For example, the controller 101 may control the first part 121 to move in a direction toward the second part 122. Therefore, the controller 101 may decrease the gap D between the first part 121 and the second part 122.

According to one or more embodiments, the controller 101 may control the gap D between the first part 121 and the second part 122 based on a type of the measurement target 102.

More specifically, the controller 101 may determine the type of the measurement target 102 based on type information (TI) received from an outside of the semiconductor measuring device 100.

For example, the controller 101 may determine that the measurement target 102 corresponds to a first type based on the type information (TI) received from the outside of the semiconductor measuring device 100.

For example, the measurement target corresponding to the first type may include a mold of a V-NAND. Here, for example, the measurement target corresponding to the first type may have an average thickness of about 12.3 μm or more.

In another example, the controller 101 may determine that the measurement target 102 corresponds to a second type based on the type information (TI) received from the outside of the semiconductor measuring device 100.

For example, the measurement target corresponding to the second type may include a cell block of a DRAM.

Here, for example, it can be understood that the type information (TI) is recipe data for a semiconductor device (or an element) transmitted through a Front Opening Unified Pod (FOUP), but is not limited to thereto.

It can be understood that the measurement target corresponding to the first type has a relatively larger average thickness than the measurement target corresponding to the second type.

However, the configuration of the measurement target 102 is not limited to the above-described types of the measurement target 102 and the examples of the respective types.

According to one or more embodiments, the semiconductor measuring device 100 may store the gap between the first part 121 and the second part 122, which corresponds to the type of the measurement target 102.

For example, the semiconductor measuring device 100 may further include an internal storage device for storing the gap between the first part 121 and the second part 122, which corresponds to the type of the measurement target 102.

In addition, for example, the gap between the first part 121 and the second part 122, which corresponds to the type of the measurement target 102 may be stored in a form of a lookup table.

Therefore, in response to determining the type of the measurement target 102, the controller 101 may determine the gap between the first part 121 and the second part 122, which corresponds to the type of the measurement target 102 from pre-stored data.

Furthermore, the controller 101 may change the position of at least one of the first part 121 and the second part 122 so that the first part 121 and the second part 122 have the gap D corresponding to the type of the measurement target 102.

More specifically, when the measurement target 102 is the first type, the controller 101 may move at least one of the first part 121 and the second part 122 so that the first part 121 and the second part 122 have a first gap corresponding to the first type.

For example, when the measurement target 102 is the first type, the controller 101 may each move the first part 121 and the second part 122 in a direction opposite to each other so that the first part 121 and the second part 122 have the first gap corresponding to the first type.

In addition, when the measurement target 102 is the second type, the controller 101 may move at least one of the first part 121 and the second part 122 so that the first part 121 and the second part 122 have a second gap corresponding to the second type.

Referring to the above-described configurations, the controller 101 according to one or more embodiments may control a size of the pinhole of the aperture 120 through which the reflected light RL passes, depending on the measurement target 102.

Therefore, the semiconductor measuring device 100 according to the embodiment of the present disclosure can measure thicknesses of different measurement targets 102 without replacing any component (e.g., the light source 110 and the aperture 120).

Furthermore, the controller 101 according to one or more embodiments may detect the gap D between the first part 121 and the second part 122 using at least one sensor 130.

The controller 101 may detect the size of the pinhole formed by the aperture 120 using at least one sensor 130.

More specifically, after controlling at least one of the first part 121 and the second part 122, the controller 101 may detect the gap D between the first part 121 and the second part 122 using the at least one sensor 130.

For example, after moving the first part 121 so that the first part 121 and the second part 122 have the first gap, the controller 101 may detect whether the first part 121 and the second part 122 have the first gap using at least one sensor 130.

For another example, after moving the first part 121 and the second part 122 so that the first part 121 and the second part 122 have the second gap, the controller 101 may detect whether the first part 121 and the second part 122 have the second gap using at least one sensor 130.

That is, after controlling the aperture 120, the controller 101 may determine whether the aperture 120 forms the pinhole with the size corresponding to the type of the measurement target 102 using the at least one sensor 130.

After controlling at least one of the first part 121 and the second part 122, the controller 101 may determine whether the first part 121 and the second part 122 have the gap corresponding to the type of the measurement target 102 using at least one sensor 130.

Furthermore, when the first part 121 and the second part 122 have the gap corresponding to the type of the measurement target 102, the controller 101 may measure the thickness of the measurement target 102.

On the other hand, when the gap D between the first part 121 and the second part 122 does not correspond to the type of the measurement target 102, the controller 101 may output error data.

Referring to the above-described configurations, after controlling the aperture 120, the controller 101 according to one or more embodiments may determine whether the aperture 120 forms the pinhole with the size corresponding to the type of the measurement target 102.

Therefore, the semiconductor measuring device 100 according to the embodiment of the present disclosure can increase accuracy in measuring the thickness of the measurement target 102.

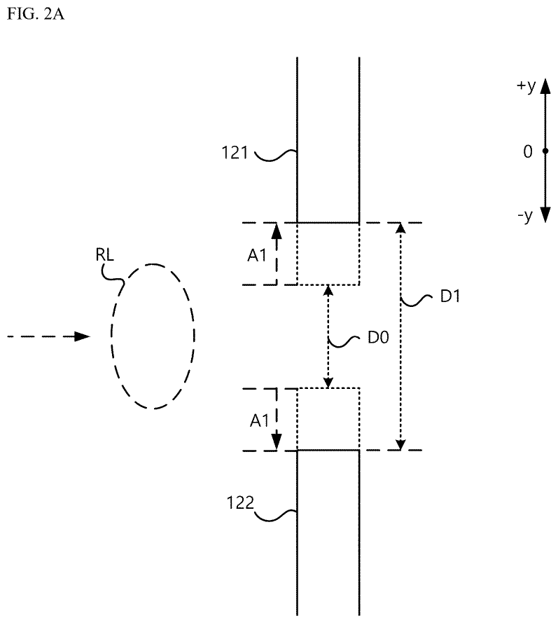

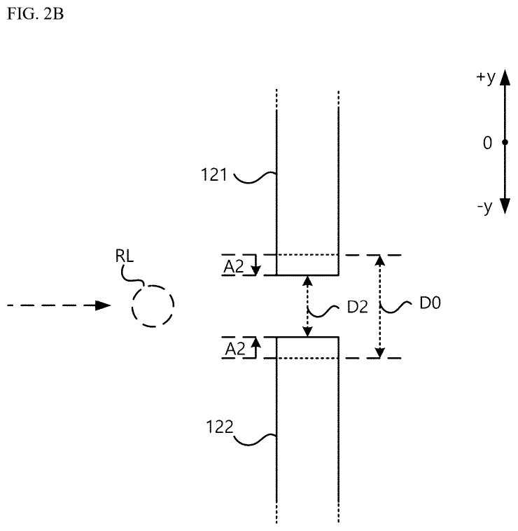

FIG. 2A shows a configuration in which a controller according to one or more embodiments controls a first part and a second part so that the first part and the second part have a first gap. FIG. 2B shows a configuration in which the controller according to one or more embodiments controls the first part and the second part so that the first part and the second part have a second gap.

Referring to FIGS. 2A and 2B together, the controller 101 according to one or more embodiments may move the first part 121 and the second part 122 so that the first part 121 and the second part 122 have a specific gap.

Referring to FIG. 2A according to one or more embodiments, the controller 101 may move the first part 121 and the second part 122 so that the first part 121 and the second part 122 have a first gap D1 in response to determining that the measurement target 102 corresponds to the first type.

More specifically, the controller 101 may move the first part 121 and the second part 122 in response to determining that the measurement target 102 corresponds to the first type from a state in which the first part 121 and the second part 122 have a default gap DO.

For example, the controller 101 may move the first part 121 in a first direction (e.g., a ty direction) by a first distance A1. In addition, the controller 101 may move the second part 122 in a second direction (e.g., a-y direction) that is a direction opposite to the first direction by the first distance A1.

That is, the controller 101 may increase the gap between the first part 121 and the second part 122 into the first gap D1 by moving the first part 121 and the second part 122 in the direction opposite to each other from the state in which the first part 121 and the second part 122 have the default gap DO.

Here, for example, it can be understood that the first gap D1 is a distance through which a specified proportion or more of a beam composed of the reflected light RL may pass.

That is, when the measurement target 102 corresponds to the relatively thick first type, the controller 101 may control the size of the pinhole of the aperture 120 so that the specified proportion or more of the reflected light RL reflected from the first type of the measurement target 102 may pass through.

Here, it can be understood that the reflected light RL shown in FIGS. 2A and 2B is a beam formed by the reflected light RL reflected from the measurement target 102.

Referring to the above-described configurations, when the measurement target 102 corresponds to the relatively thick first type, the controller 101 may increase the gap D between the first part 121 and the second part 122 so that the specified proportion or more of the reflected light RL may pass through.

Therefore, the semiconductor measuring device 100 according to the embodiment of the present disclosure can accurately measure the thickness of the relatively thick measurement target without replacing any component.

In addition, referring to FIG. 2B according to one or more embodiments, the controller 101 may move the first part 121 and the second part 122 so that the first part 121 and the second part 122 have a second gap D2 in response to determining that the measurement target 102 corresponds to the second type.

More specifically, the controller 101 may move the first part 121 and the second part 122 in response to determining that the measurement target 102 corresponds to the second type from the state in which the first part 121 and the second part 122 have the default gap DO.

For example, the controller 101 may move the first part 121 in the second direction (e.g., the −y direction) by a second distance A2. In addition, the controller 101 may move the second part 122 in the first direction (e.g., the +y direction) by the second distance A2.

That is, the controller 101 may decrease the gap between the first part 121 and the second part 122 into the second gap D2 by moving the first part 121 and the second part 122 122 in the direction opposite to each other from the state in which the first part 121 and the second part 122 have the default gap DO.

Here, for example, it can be understood that the second gap D2 is a distance in which the intensity of light is maintained in a specified proportion or more as the beam composed of the reflected light RL passes through the aperture 120.

That is, when the measurement target 102 corresponds to the relatively thin second type, the controller 101 may control the size of the pinhole of the aperture 120 to correspond to the second type.

Therefore, when the measurement target 102 corresponds to the relatively thin second type, the controller 101 can minimize the decrease in the intensity of the reflected light RL by decreasing the size of the pinhole of the aperture 120.

Referring to the above-described configurations, when the measurement target 102 corresponds to the relatively thin second type, the controller 101 may decrease the gap D between the first part 121 and the second part 122 to correspond to the second type.

Therefore, the semiconductor measuring device 100 according to the embodiment of the present disclosure can accurately measure the thickness of the relatively thin measurement target without replacing any component.

Referring to FIGS. 2A and 2B together, the controller 101 according to one or more embodiments may control the size of the pinhole of the aperture 120 through which the reflected light RL passes depending on the type of the measurement target 102 (or an average thickness of the measurement target 102).

Therefore, the semiconductor measuring device 100 according to the embodiment of the present disclosure can measure the thicknesses of different measurement targets 102 without replacing any component (e.g., the light source 110 and the aperture 120).

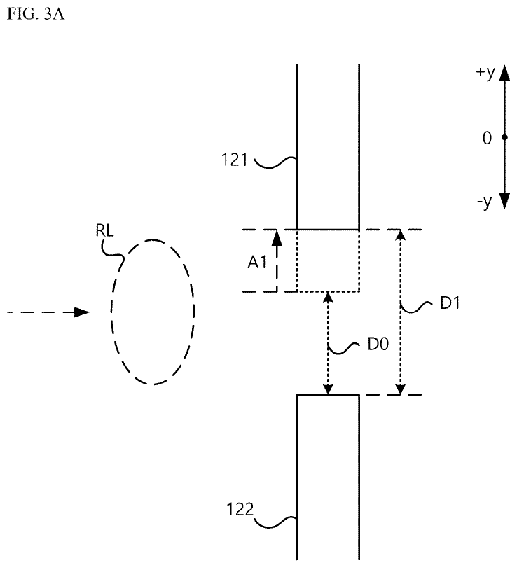

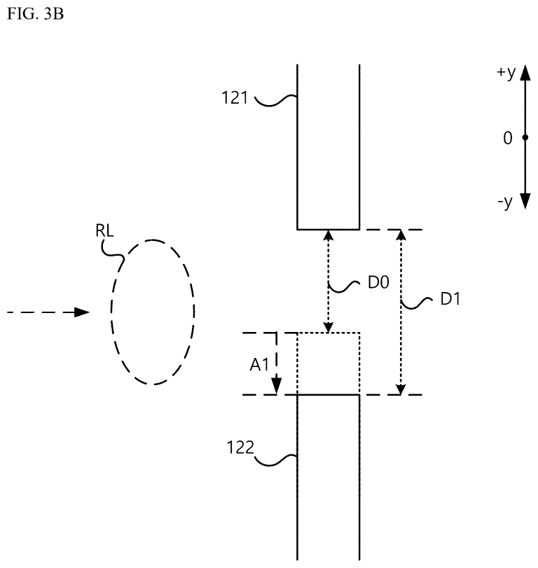

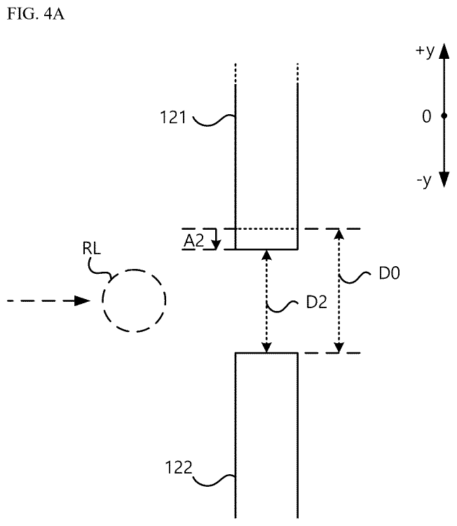

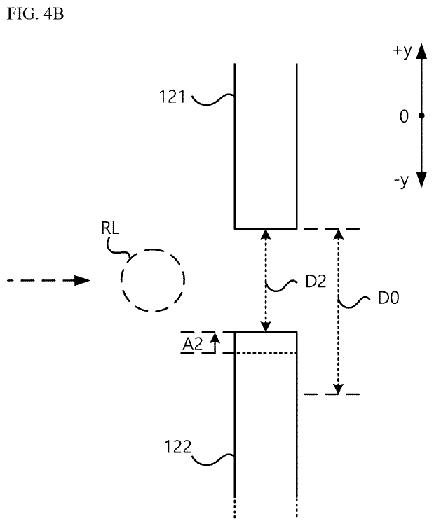

FIG. 3A shows a configuration in which the controller according to one or more embodiments controls the first part so that the first part and the second part have the first gap. FIG. 3B shows a configuration in which the controller according to one or more embodiments controls the second part so that the first part and the second part have the first gap. FIG. 4A shows a configuration in which the controller according to one or more embodiments controls the first part so that the first part and the second part have the second gap. FIG. 4B shows a configuration in which the controller according to one or more embodiments controls the second part so that the first part and the second part have the second gap.

Referring to FIGS. 3A and 3B together, the controller 101 according to one or more embodiments may move any one among the first part 121 and the second part 122 so that the first part 121 and the second part 122 have the first gap D1.

Referring to FIG. 3A according to one or more embodiments, the controller 101 may move the first part 121 so that the first part 121 and the second part 122 have the first gap D1 in response to determining that the measurement target 102 corresponds to the first type.

More specifically, the controller 101 may move the first part 121 in response to determining that the measurement target 102 corresponds to the first type from the state in which the first part 121 and the second part 122 have the default gap DO.

For example, the controller 101 may move the first part 121 in the first direction (e.g., the +y direction) by the first distance A1.

That is, the controller 101 may increase the gap between the first part 121 and the second part 122 into the first gap D1 by moving the first part 121 from the state in which the first part 121 and the second part 122 have the default gap DO.

Here, for example, it can be understood that the first gap D1 is a distance through which a specified proportion or more of a beam composed of the reflected light RL may pass.

In addition, referring to FIG. 3B according to another embodiment, the controller 101 may move the second part 122 so that the first part 121 and the second part 122 have the first gap D1 in response to determining that the measurement target 102 corresponds to the first type.

More specifically, the controller 101 may move the second part 122 in response to determining that the measurement target 102 corresponds to the first type from the state in which the first part 121 and the second part 122 have the default gap DO.

For example, the controller 101 may move the second part 122 in the second direction (e.g., the −y direction) by the first distance A1.

That is, the controller 101 may increase the gap between the first part 121 and the second part 122 into the first gap D1 by moving the second part 122 from the state in which the first part 121 and the second part 122 have the default gap DO.

That is, when the measurement target 102 corresponds to the relatively thin second type, the controller 101 may control the size of the pinhole of the aperture 120 to correspond to the first type.

Referring to the above-described configurations, when the measurement target 102 corresponds to the relatively thick first type, the controller 101 may control any one of the first part 121 and the second part 122 of the aperture 120 so that the specified proportion or more of the reflected light RL reflected from the first type of the measurement target 102 may pass through.

Therefore, the semiconductor measuring device 100 according to the embodiment of the present disclosure can accurately measure the thickness of the relatively thick measurement target without replacing any component.

Referring to FIGS. 4A and 4B together, the controller 101 according to one or more embodiments may move any one of the first part 121 and the second part 122 so that the first part 121 and the second part 122 have the second gap D2.

Referring to FIG. 4A according to one or more embodiments, the controller 101 may move the first part 121 so that the first part 121 and the second part 122 have the second gap D2 in response to determining that the measurement target 102 corresponds to the second type.

More specifically, the controller 101 may move the first part 121 in response to determining that the measurement target 102 corresponds to the second type from the state in which the first part 121 and the second part 122 have the default gap DO.

For example, the controller 101 may move the first part 121 in the second direction (e.g., the −y direction) by the second distance A2.

That is, the controller 101 may decrease the gap between the first part 121 and the second part 122 into the second gap D2 by moving the first part 121 from the state in which the first part 121 and the second part 122 have the default gap DO.

Here, for example, it can be understood that the second gap D2 is a distance at which the intensity of light is maintained in a specified proportion or more as the beam composed of the reflected light RL passes through the aperture 120.

Referring to FIG. 4B according to another embodiment, the controller 101 may move the second part 122 so that the first part 121 and the second part 122 have the second gap D2 in response to determining that the measurement target 102 corresponds to the second type.

More specifically, the controller 101 may move the second part 122 in response to determining that the measurement target 102 corresponds to the second type from the state in which the first part 121 and the second part 122 have the default gap DO.

For example, the controller 101 may move the second part 122 in the first direction (e.g., the ty direction) by the second distance A2.

That is, the controller 101 may decrease the gap between the first part 121 and the second part 122 into the second gap D2 by moving the second part 122 from the state in which the first part 121 and the second part 122 have the default gap DO.

That is, when the measurement target 102 corresponds to the relatively thin second type, the controller 101 may control the size of the pinhole of the aperture 120 to correspond to the second type.

Referring to the above-described configurations, when the measurement target 102 corresponds to the relatively thin second type, the controller 101 may control any one of the first part 121 and the second part 122 so that the aperture 120 has the pinhole with the size corresponding to the second type.

Therefore, the semiconductor measuring device 100 according to the embodiment of the present disclosure can accurately measure a thickness of a relatively thin measurement target without replacing any component.

Referring to FIGS. 3A to 4B together, the controller 101 according to one or more embodiments may control the size of the pinhole of the aperture 120 through which the reflected light RL passes depending on the type of the measurement target 102 (or the average thickness of the measurement target 102).

Therefore, the semiconductor measuring device 100 according to the embodiment of the present disclosure can measure the thicknesses of different measurement targets 102 without replacing any component (e.g., the light source 110 and the aperture 120).

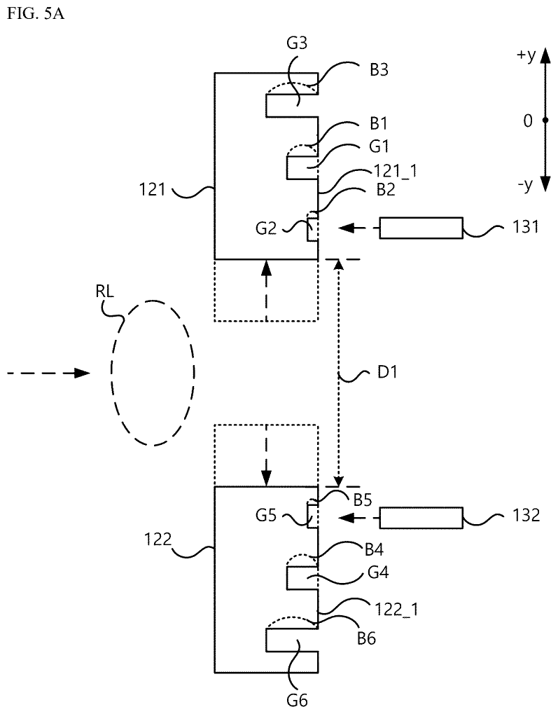

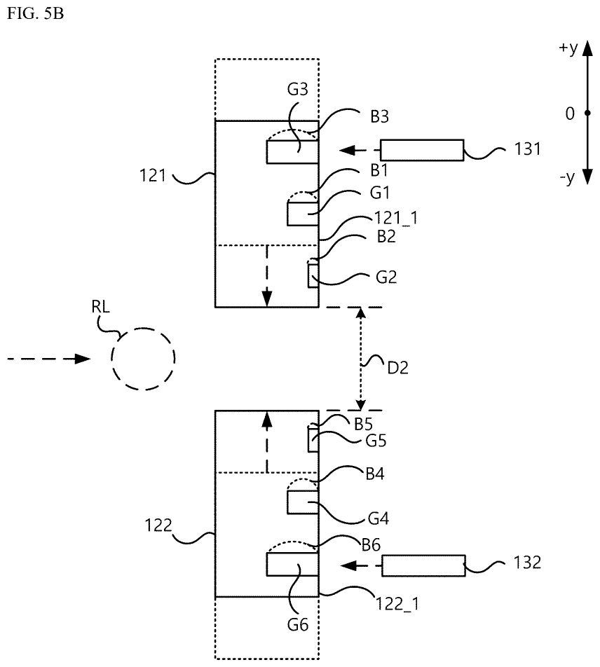

FIG. 5A shows a configuration in which at least one sensor according to one or more embodiments determines whether the first part and the second part have the first gap using recesses formed in each of the first part and the second part. FIG. 5B shows a configuration in which at least one sensor according to one or more embodiments determines whether the first part and the second part have the second gap using recesses formed in each of the first part and the second part.

Referring to FIGS. 5A and 5B together, the controller 101 according to one or more embodiments may acquire the pieces of position data of the first part 121 and the second part 122 using the first sensor 131 and the second sensor 132.

The controller 101 may acquire first position data of the first part 121 using the first sensor 131. Here, for example, the first position data may include at least some of the moving direction, moving distance, and current position of the first part 121.

According to one or more embodiments, the first part 121 may include a plurality of recesses G1, G2, and G3 having different depths on a first surface 121_1 adjacent to the first sensor 131.

More specifically, the first part 121 may include the first recess G1 formed on the first surface 121_1 to have a first depth B1. In addition, the first part 121 may include the second recess G2 formed on the first surface 121_1 to have a second depth B2 smaller than the first depth B1. In addition, the first part 121 may also include the third recess G3 formed on the first surface 121_1 to have a third depth B3 larger than the first depth B1.

The first sensor 131 according to one or more embodiments may output a signal (e.g., an optical signal) toward the first surface 121_1 of the first part 121. Furthermore, the first sensor 131 may acquire a signal reflected from the first surface 121_1.

Therefore, for example, the first sensor 131 may be referred to as a time of flight (ToF) sensor or a light detection and ranging (LiDAR) sensor, but is not limited to thereto.

The controller 101 may store a time when the signal output from the first sensor 131 is received by being reflected, corresponding to each of the plurality of recesses G1, G2, and G3.

Therefore, the controller 101 may identify a recess that is present at a position corresponding to the first sensor 131 based on the time until the signal output from the first sensor 131 is received by being reflected from the first surface 121_1.

For example, when a first time elapses from a time point when the signal is output toward the first surface 121_1 until the reflected signal is received, the first sensor 131 may detect that the first recess G1 is located at the position corresponding to the first sensor 131.

In addition, for another example, when a second time, which is shorter than the first time, elapses from the time point when the signal is output toward the first surface 1211 until the reflected signal is received, the first sensor 131 may detect that the relatively shallow second recess G2 is located at the position corresponding to the first sensor 131.

For still another example, when a third time, which is longer than the first time, elapses from the time point when the signal is output toward the first surface 121_1 until the reflected signal is received, the first sensor 131 may detect that the relatively deep third recess G3 is located at the position corresponding to the first sensor 131.

Through this, the controller 101 may determine a direction and/or distance in which the first part 121 has moved.

For example, referring to FIG. 5A, when the time detected by the first sensor 131 decreases, the controller 101 may determine that the first part 121 has moved in the first direction (e.g., the +y direction).

In another example, referring to FIG. 5B, when the time detected by the first sensor 131 increases, the controller 101 may determine that the first part 121 has moved in the second direction (e.g., the −y direction).

In addition, the controller 101 may acquire the second position data of the second part 122 using the second sensor 132. For example, the second position data may include at least some of the moving direction, moving distance, and current position of the second part 122.

According to one or more embodiments, the second part 122 may include a plurality of recesses G4, G5, and G6 having different depths on a second surface 122_1 adjacent to the second sensor 132.

More specifically, the second part 122 may include the fourth recess G4 formed on the second surface 122_1 to have a fourth depth B4. In addition, the second part 122 may include the fifth recess G5 formed on the second surface 122_1 to have a fifth depth B5 smaller than the fourth depth B4. In addition, the second part 122 may also include the sixth recess G6 formed on the second surface 122_1 to have a sixth depth B6 larger than the fourth depth B4.

The second sensor 132 according to one or more embodiments may output a signal (e.g., an optical signal) toward the second surface 122_1 of the second part 122. Furthermore, the second sensor 132 may acquire the signal reflected from the second surface 122_1.

Therefore, for example, the second sensor 132 may be referred to as a time of flight (ToF) sensor or a light detection and ranging (LiDAR) sensor, but is not limited to thereto.

The controller 101 may store the time when a signal output from the second sensor 132 is received by being reflected corresponding to each of the plurality of recesses G4, G5, and G6.

Therefore, the controller 101 may identify a recess that is present at a position corresponding to the second sensor 132 based on the time until the signal output from the second sensor 132 is received by being reflected from the second surface 122_1.

For example, when a fourth time elapses from a time point when the signal is output toward the second surface 122_1 until the reflected signal is received, the second sensor 132 may detect that the first recess G4 is located at the position corresponding to the second sensor 132.

In addition, as another example, when a fifth time, which is shorter than the fourth time, elapses from the time point when the signal is output toward the second surface 122_1 until the reflected signal is received, the second sensor 132 may detect that the relatively shallow fifth recess G5 is located at the position corresponding to the second sensor 132.

As still another example, when a sixth time, which is longer than the fourth time, elapses from the time point when the signal is output toward the second surface 122_1 until the reflected signal is received, the second sensor 132 may detect that the relatively deep sixth recess G6 is located at the position corresponding to the second sensor 132.

Through this, the controller 101 may determine a direction and/or distance in which the second part 122 has moved.

For example, referring to FIG. 5A, when the time detected by the second sensor 132 decreases, the controller 101 may determine that the second part 122 has moved in the second direction (e.g., the −y direction).

In another example, referring to FIG. 5B, when the time detected by the second sensor 132 increases, the controller 101 may determine that the second part 122 has moved in the first direction (e.g., the ty direction).

Referring to the above-described configurations, the controller 101 according to one or more embodiments may acquire the first position data of the first part 121 using the first sensor 131. In addition, the controller 101 may acquire the second position data of the second part 122 using the second sensor 132.

Furthermore, the controller 101 may detect the gap between the first part 121 and the second part 122 using at least one of the first position data and the second position data.

For example, referring to FIG. 5A, the controller 101 may determine that the first part 121 and the second part 122 have the first gap D1 when the second recess G2 is positioned to correspond to the first sensor 131 and the fifth recess G5 is positioned to correspond to the second sensor 132.

For another example, referring to FIG. 5B, the controller 101 may determine that the first part 121 and the second part 122 have the second gap D2 when the third recess G3 is positioned to correspond to the first sensor 131 and the sixth recess G6 is positioned to correspond to the second sensor 132.

Through this, the controller 101 may determine whether the first part 121 and the second part 122 have the gap D corresponding to the type of the measurement target 102.

For example, when the measurement target 102 corresponds to the first type, the controller 101 may control the first part 121 and the second part 122 to have the first gap D1. Furthermore, the controller 101 may detect whether the first part 121 and the second part 122 have the first gap D1 using the first sensor 131 and the second sensor 132.

In another example, when the measurement target 102 corresponds to the second type, the controller 101 may control the first part 121 and the second part 122 to have the second gap D2. Furthermore, the controller 101 may detect whether the first part 121 and the second part 122 have the second gap D2 using the first sensor 131 and the second sensor 132.

Furthermore, for example, when the first part 121 and the second part 122 have the gap corresponding to the type of the measurement target 102, the controller 101 may measure a thickness of the measurement target 102.

On the other hand, when the gap D between the first part 121 and the second part 122 does not correspond to the type of the measurement target 102, the controller 101 may output error data.

Referring to the above-described configurations, the controller 101 according to one or more embodiments may determine whether the aperture 120 forms the pinhole with the size corresponding to the type of the measurement target 102 after controlling the aperture 120.

After controlling the first part 121 and the second part 122, the controller 101 may determine whether the first part 121 and the second part 122 have the gap corresponding to the type of the measurement target 102.

Therefore, the semiconductor measuring device 100 according to the embodiment of the present disclosure can increase accuracy in measuring the thickness of the measurement target 102.

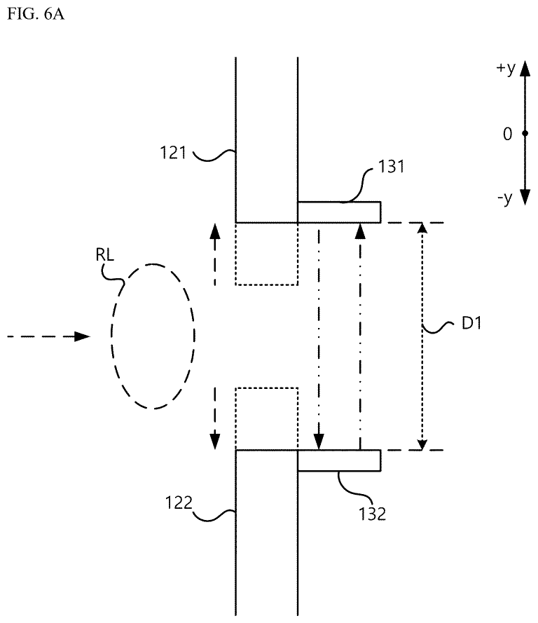

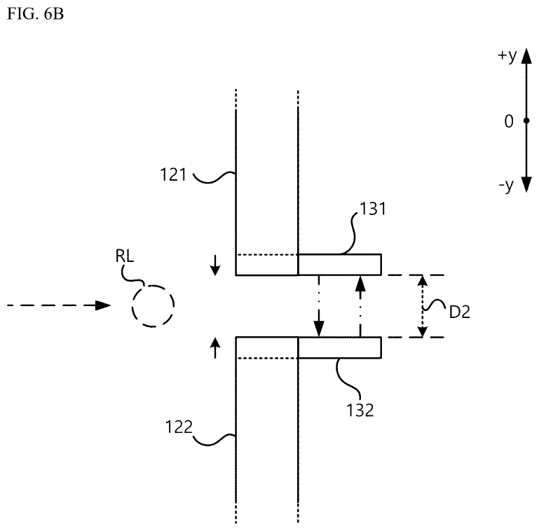

FIG. 6A shows a configuration in which the controller according to one or more embodiments determines whether the first part and the second part have the first gap using a first sensor and a second sensor that are attached to each of the portions. FIG. 6B shows a configuration in which the controller according to one or more embodiments determines whether the first part and the second part have the second gap using the first sensor and the second sensor that are attached to each of the portions.

Referring to FIGS. 6A and 6B together, the semiconductor measuring device 100 according to one or more embodiments may include the first sensor 131 attached to the first part 121 and the second sensor 132 attached to the second part 122.

According to one or more embodiments, the first sensor 131 may output a signal (e.g., an optical signal) toward the second sensor 132. In addition, the first sensor 131 may acquire the signal reflected from the second sensor 132. Here, the first sensor 131 may detect a time from a time point when the signal is output to a time point when the output signal is acquired by being reflected.

According to another embodiment, the second sensor 132 may output a signal toward the first sensor 131 and acquire a signal reflected from the first sensor 131.

Therefore, for example, the first sensor 131 and the second sensor 132 may be referred to as a time of flight (ToF) sensor or a light detection and ranging (LiDAR) sensor.

However, the configurations and type of the first sensor 131 and the second sensor 132 are not limited to the above-described examples, and may be referred to as various types of sensors capable of detecting the gap D between the first part 121 and the second part 122 through the positions of the first part 121 and the second part 122.

According to one or more embodiments, the controller 101 may detect the gap D between the first part 121 and the second part 122 based on a time until the signal output from the first sensor 131 is reflected from the second sensor 132 and input to the first sensor 131.

For example, referring to FIG. 6A, the controller 101 may determine that the first part 121 and the second part 122 have the first gap D1 based on the time until the signal output from the first sensor 131 is reflected from the second sensor 132 and input to the first sensor 131.

For another example, referring to FIG. 6B, the controller 101 may determine that the first part 121 and the second part 122 have the second gap D2 based on the time until the signal output from the first sensor 131 is reflected from the second sensor 132 and input to the first sensor 131.

Through this, the controller 101 may determine whether the first part 121 and the second part 122 have the gap corresponding to the type of the measurement target 102.

For example, referring to FIG. 6A, when the measurement target 102 corresponds to the first type, the controller 101 may control the first part 121 and the second part 122 to have the first gap D1. Furthermore, the controller 101 may detect whether the first part 121 and the second part 122 have the first gap D1 using the first sensor 131 and the second sensor 132.

In another example, when the measurement target 102 corresponds to the second type, the controller 101 may control the first part 121 and the second part 122 to have the second gap D2. Furthermore, the controller 101 may detect whether the first part 121 and the second part 122 have the second gap D2 using the first sensor 131 and the second sensor 132.

Furthermore, for example, when the first part 121 and the second part 122 have the gap corresponding to the type of the measurement target 102, the controller 101 may measure the thickness of the measurement target 102.

On the other hand, when the gap D between the first part 121 and the second part 122 does not correspond to the type of the measurement target 102, the controller 101 may output error data.

Referring to the above-described configurations, the controller 101 according to one or more embodiments may determine whether the aperture 120 forms the pinhole with the size corresponding to the type of the measurement target 102 after controlling the aperture 120.

After controlling the first part 121 and the second part 122, the controller 101 may determine whether the first part 121 and the second part 122 have the gap corresponding to the type of the measurement target 102.

Therefore, the semiconductor measuring device 100 according to the embodiment of the present disclosure can increase accuracy in measuring the thickness of the measurement target 102.

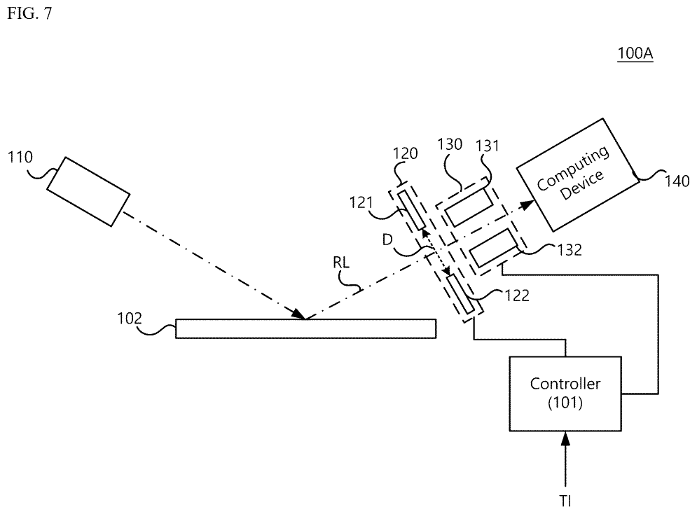

FIG. 7 shows a semiconductor measuring device further including a computing device for calculating a thickness of a measurement target using polarization information about reflected light according to one or more embodiments.

Referring to FIG. 7, a semiconductor measuring device 100A according to one or more embodiments may include the light source 110, the aperture 120, at least one sensor 130, the controller 101, and a computing device 140.

Here, it can be understood that the semiconductor measuring device 100A shown in FIG. 7 is one example of the semiconductor measuring device 100 shown in FIG. 1. In addition, it can be understood that the semiconductor measuring device 100A shown in FIG. 7 further include the computing device 140 in the configuration of the semiconductor measuring device 100 shown in FIG. 1.

Therefore, the same reference numerals are used for configurations that are the same or substantially the same as the above-described configurations, and descriptions that overlap the above-described contents will be omitted.

The semiconductor measuring device 100A may include the computing device 140 that calculates the thickness of the measurement target 102 using the reflected light RL that passes through the aperture 120. Here, the computing device 140 may be disposed on a light path along which the reflected light RL passing through the aperture 120 travels.

More specifically, the computing device 140 may calculate the thickness of the measurement target 102 based on polarization information about the reflected light RL passing through the aperture 120.

According to one or more embodiments, the controller 101 may determine the type of the measurement target 102 based on type information (TI) received from an outside of the semiconductor measuring device 100A.

Furthermore, the controller 101 may control at least one of the first part 121 and the second part 122 so that the aperture 120 has a pinhole with a size corresponding to the type of the measurement target 102.

In addition, after controlling the aperture 120, the controller 101 may determine whether the aperture 120 has the pinhole with the size corresponding to the type of the measurement target 102 using at least one sensor 130.

After controlling the at least one of the first part 121 and the second part 122, the controller 101 may determine whether the first part 121 and the second part 122 have a gap corresponding to the type of the measurement target 102 using the at least one sensor 130.

In addition, when it is determined that the first part 121 and the second part 122 have the gap corresponding to the type of the measurement target 102, the controller 101 may calculate the thickness of the measurement target 102 using the computing device 140.

On the other hand, the controller 101 may output error data when it is determined that the gap D between the first part 121 and the second part 122 does not correspond to the type of the measurement target 102.

Referring to the above-described configurations, the controller 101 according to one or more embodiments may control a size of the pinhole of the aperture 120 through which the reflected light RL passes, depending on the measurement target 102.

Therefore, the semiconductor measuring device 100A according to the embodiment of the present disclosure can measure the thickness of different types of measurement targets 102 without replacing any component.

In addition, after controlling the first part 121 and the second part 122, the controller 101 may determine whether the first part 121 and the second part 122 have the gap D corresponding to the type of the measurement target 102 using the at least one sensor 130.

Therefore, the semiconductor measuring device 100A according to the embodiment of the present disclosure can increase accuracy in measuring the thickness of the measurement target 102.

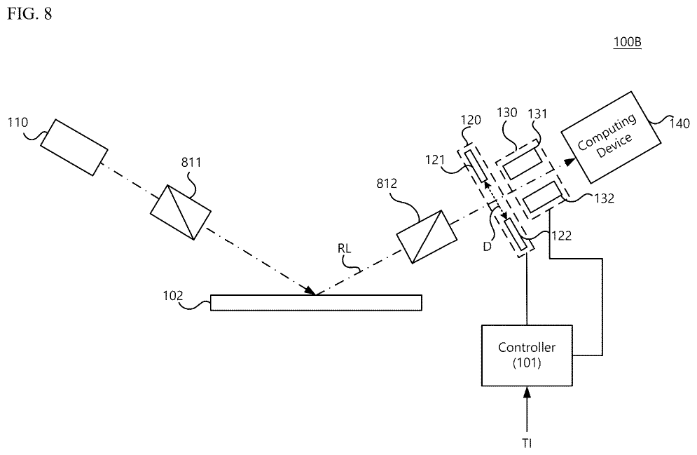

FIG. 8 shows a semiconductor measuring device further including a polarizer and an analyzer according to one or more embodiments.

Referring to FIG. 8, a semiconductor measuring device 100B according to one or more embodiments may include the light source 110, the aperture 120, at least one sensor 130, the controller 101, the computing device 140, a polarizer 811, and an analyzer 812.

Here, it can be understood that the semiconductor measuring device 100B shown in FIG. 8 is one example of the semiconductor measuring device 100 shown in FIG. 1. In addition, it can be understood that the semiconductor measuring device 100B shown in FIG. 8 further includes the polarizer 811 and the analyzer 812 in the configuration of the semiconductor measuring device 100 shown in FIG. 1.

Therefore, the same reference numerals are used for configurations that are the same or substantially the same as the above-described configurations, and descriptions that overlap the above-described contents will be omitted.

The semiconductor measuring device 100B may include a polarizer 811 disposed between the light source 110 and the measurement target 102. More specifically, the polarizer 811 may be disposed on a light path along which light output from the light source 110 travels to the measurement target 102.

According to one or more embodiments, the polarizer 811 may control a polarization direction of the light output from the light source 110. Here, the polarizer 811 may include at least one element for controlling the polarization direction of incident light.

The polarizer 811 may be electrically connected to the controller 101. Therefore, the controller 101 may control the polarization direction of the light output from the light source 110 through the polarizer 811.

In addition, the semiconductor measuring device 100B may include the analyzer 812 disposed between the measurement target 102 and the computing device 140. More specifically, the analyzer 812 may be disposed on a light path along which the reflected light RL reflected from the measurement target 102 travels to the aperture 120 (or the computing device 140).

According to one or more embodiments, the analyzer 812 may acquire polarization information about the reflected light RL from the reflected light RL. More specifically, the analyzer 812 may acquire the polarization information about the reflected light RL by acquiring the reflected light RL.

In addition, the analyzer 812 may control the polarization direction of the reflected light RL. Here, the analyzer 812 may include at least one element for controlling the polarization direction of the reflected light RL.

The analyzer 812 may be electrically connected to the controller 101. Therefore, the controller 101 may control the polarization direction of the light output from the light source 110 through the analyzer 812.

Furthermore, the computing device 140 may calculate the thickness of the measurement target 102 based on the polarization information acquired through the analyzer 812 in response to the aperture 120 having the pinhole with the size corresponding to the type of the measurement target 102.

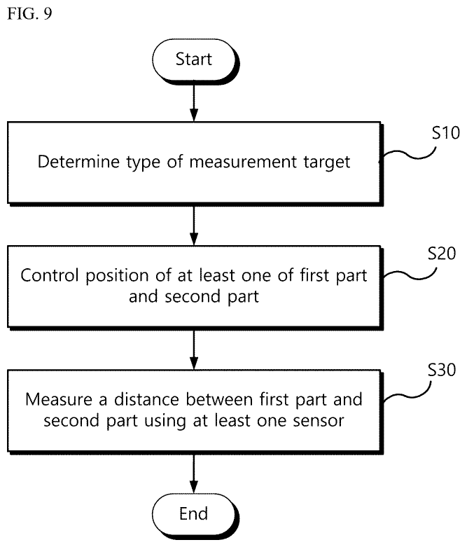

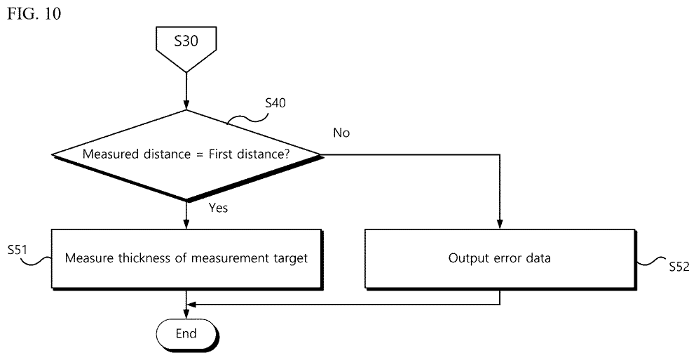

FIG. 9 is a flow chart showing a method for measuring a thickness of a measurement target by the semiconductor measuring device according to one or more embodiments. FIG. 10 is a flow chart showing a method for measuring the thickness of the measurement target based on whether the first part and the second part have the first gap according to one or more embodiments.

Referring to FIGS. 9 and 10 together, the controller 101 (or the semiconductor measuring device 100) according to one or more embodiments may control the size of the pinhole of the aperture 120 depending on the type of the measurement target 102.

Furthermore, the controller 101 may determine whether the aperture 120 forms the pinhole with the size corresponding to the type of the measurement target 102 using at least one sensor 130.

In step S10, the controller 101 according to one or more embodiments may determine the type of the measurement target 102.

More specifically, the controller 101 may determine the type of the measurement target 102 based on the type information (TI) received from the outside of the semiconductor measuring device 100.

For example, the controller 101 may determine that the measurement target 102 corresponds to the first type as a mold of a V-NAND based on the type information (TI) received from the outside of the semiconductor measuring device 100.

For another example, the controller 101 may determine that the measurement target 102 corresponds to the second type as a cell block of a DRAM based on type information (TI) received from the outside of the semiconductor measuring device 100.

Here, for example, the measurement target corresponding to the first type may have a relatively larger average thickness than the measurement target corresponding to the second type.

That is, for example, the type of the measurement target 102 may be classified according to an average thickness of the devices corresponding to the respective types. However, the classification for the type of the measurement target 102 is not limited to the above-described examples and may be classified by various physical characteristics of the measurement target 102.

In step S20, the controller 101 according to one or more embodiments may control at least one of the first part 121 and the second part 122 that are included in the aperture 120.

More specifically, the controller 101 may control at least one of the first part 121 and the second part 122 so that the aperture 120 has the pinhole with the size corresponding to the type of the measurement target 102.

The controller 101 may control at least one of the first part 121 and the second part 122 so that the first part 121 and the second part 122 have the gap D corresponding to the type of the measurement target 102.

For example, the controller 101 may move the first part 121 and the second part 122 in the direction opposite to each other so that the first part 121 and the second part 122 have the first gap D1 corresponding to the first type of measurement target 102.

In another example, the controller 101 may move the first part 121 in a specified direction so that the first part 121 and the second part 122 have the second gap D2 corresponding to the second type of measurement target 102.

Referring to the above-described configurations, the controller 101 according to one or more embodiments may control the size of the pinhole of the aperture 120 through which the reflected light RL passes depending on the type (or a category) of the measurement target 102.

Therefore, the semiconductor measuring device 100 according to the embodiment of the present disclosure can measure thicknesses of different measurement targets 102 without replacing any component (e.g., the light source 110 and the aperture 120).

In step S30, the controller 101 may measure the gap D between the first part 121 and the second part 122 using at least one sensor 130.

More specifically, the controller 101 may detect a position of each of the first part 121 and the second part 122 using at least one sensor 130.

For example, the controller 101 may detect the position of the first part 121 using a first sensor 131. In addition, the controller 101 may detect the position of the second part 122 using a second sensor 132.

Furthermore, referring to FIG. 10, the controller 101 according to one or more embodiments may measure the thickness of the measurement target 102 based on whether the first part 121 and the second part 122 have a gap corresponding to the type of the measurement target 102.

In step S40, the controller 101 may determine whether the first part 121 and the second part 122 have the first gap D1.

More specifically, after moving the first part 121 and the second part 122, the controller 101 may determine whether the first part 121 and the second part 122 have the first gap D1 corresponding to the first type of measurement target 102 using the at least one sensor 130.

That is, after controlling the aperture 120, the controller 101 may determine whether the aperture 120 has the pinhole with the size corresponding to the type of the measurement target 102 using at least one sensor 130.

After controlling at least one of the first part 121 and the second part 122, the controller 101 may determine whether the first part 121 and the second part 122 have a gap corresponding to the type of the measurement target 102 using at least one sensor 130.

In step S51, the controller 101 according to one or more embodiments may calculate the thickness of the measurement target 102 using the computing device 140.

More specifically, when it is determined that the first part 121 and the second part 122 have the first gap D1 corresponding to the first type of measurement target 102, the controller 101 may calculate the thickness of the measurement target 102 using the computing device 140.

In step S52, the controller 101 according to one or more embodiments may output error data.

More specifically, when it is determined that the first part 121 and the second part 122 do not have the first gap D1, the controller 101 may output the error data.

Referring to the above-described configurations, after controlling the aperture 120, the controller 101 according to one or more embodiments may determine whether the aperture 120 forms the pinhole with the size corresponding to the type of the measurement target 102.

Therefore, the semiconductor measuring device 100 according to the embodiment of the present disclosure can increase accuracy in measuring the thickness of the measurement target 102.

As described above, the controller 101 according to the embodiment of the present disclosure may control the size of the pinhole of the aperture 120 through which the reflected light RL passes depending on the type (or category) of the measurement target 102.

Therefore, the semiconductor measuring device 100 according to the embodiment of the present disclosure can measure thicknesses of different measurement targets 102 without replacing any component (e.g., the light source 110 and the aperture 120).

In addition, after controlling the aperture 120, the controller 101 according to one or more embodiments may determine whether the aperture 120 forms the pinhole with the size corresponding to the type of the measurement target 102.

Therefore, the semiconductor measuring device 100 according to the embodiment of the present disclosure can increase accuracy in measuring the thickness of the measurement target 102.

The semiconductor measuring device according to one or more embodiments of the present disclosure can accurately measure thicknesses of different measurement targets without replacing any component.

In addition to the above-described embodiments, the present disclosure will also include embodiments that can be simply designed around or easily changed. In addition, the present disclosure will also include technologies that may be implemented by being easily modified using the embodiments. Therefore, the scope of the present disclosure should not be limited to the above-described embodiments, but should be defined not only by the patent claims described below but also by the equivalents of the patent claims of the present invention.

What is claimed is:

1. A semiconductor measuring device comprising:
a light source configured to output light with a specified wavelength toward a measurement target;
an aperture on a light path along which reflected light reflected from the measurement target travels and comprising a first part and a second part that are spaced apart;
at least one sensor configured to detect positions of the first part and the second part; and
a controller electrically connected to the aperture and the at least one sensor, wherein the controller is configured to:
determine a type of the measurement target based on type information;
control a position of at least one of the first part and the second part so that the first part and the second part have a gap that is a first gap corresponding to a first type based on the measurement target corresponding to the first type; and
determine whether the first part and the second part have the first gap based on the positions of the first part and the second part that are acquired from the at least one sensor.

2. The semiconductor measuring device of claim 1, further comprising:
a computing device configured to calculate a thickness of the measurement target based on polarization information about the reflected light passing through the aperture,
wherein the controller is further configured to measure the thickness of the measurement target through the computing device based on the first part and the second part having the first gap.

3. The semiconductor measuring device of claim 2, wherein the controller is further configured to output error data based on the gap between the first part and the second part differing from the first gap.

4. The semiconductor measuring device of claim 1,
wherein the controller is further configured to control the position of at least one of the first part and the second part so that the first part and the second part have a second gap corresponding to a second type based on the measurement target corresponding to the second type distinguished from the first type, and
wherein the second gap is smaller than the first gap.

5. The semiconductor measuring device of claim 1, wherein the controller is further configured to: based on the measurement target corresponding to the first type, move the first part in a first direction and move the second part in a second direction opposite to the first direction.

6. The semiconductor measuring device of claim 2,
wherein the first part comprises a first surface, and the second part comprises a second surface,
wherein the at least one sensor comprises:
a first sensor between the first surface and the computing device; and
a second sensor between the second surface and the computing device, and
wherein the controller is further configured to determine whether the first part and the second part have the first gap by using at least one of first position data of the first part measured through the first sensor and second position data of the second part measured through the second sensor.

7. The semiconductor measuring device of claim 6,
wherein the first part comprises a plurality of recesses having different depths on the first surface,
wherein the first sensor is configured to detect a direction in which the first part moves by control of the controller based on a depth measured from one of the plurality of recesses, and
wherein the controller is further configured to determine whether the first part and the second part have the first gap based on the direction in which the first part moves.

8. The semiconductor measuring device of claim 6,
wherein the first sensor is attached to the first surface and the second sensor is attached to the second surface, and
wherein the first sensor is configured to detect a change in the gap between the first part and the second part based on a time when a signal is output to the second sensor and the output signal is received by being reflected from the second sensor.

9. The semiconductor measuring device of claim 1, further comprising:
an internal storage device configured to store the gap between the first part and the second part, which corresponds to the type of the measurement target,
wherein the gap between the first part and the second part, which corresponds to the type of the measurement target, is stored as a lookup table.

10. The semiconductor measuring device of claim 2, further comprising:
a polarizer configured to control a polarization direction of the light output from the light source; and
an analyzer configured to acquire the polarization information about the reflected light by acquiring the reflected light reflected from the measurement target.

11. A method for measuring a thickness of a measurement target, the method comprising:
determining a type of the measurement target based on type information of the measurement target;
controlling a position of at least one of a first part and a second part so that the first part and the second part that are in an aperture have a gap that is a first gap corresponding to a first type based on the measurement target corresponding to the first type; and
determining whether the first part and the second part have the first gap based on position data of the first part and the second part acquired from at least one sensor.

12. The method of claim 11, further comprising:
measuring a thickness of the measurement target based on polarization information about reflected light output from a light source, reflected from the measurement target, and passing through the aperture, based on the first part and the second part having the first gap.

13. The method of claim 11, further comprising:
outputting error data based on the gap between the first part and the second part differing from the first gap.

14. The method of claim 11, further comprising:
controlling the position of at least one of the first part and the second part so that the first part and the second part have a second gap corresponding to a second type based on the measurement target corresponding to the second type distinguished from the first type,
wherein the second gap is larger than the first gap.

15. The method of claim 11, further comprising:
outputting a signal toward at least one of the first part and the second part using the at least one sensor; and
detecting the position data of the first part and the second part based on a time when the output signal is received by being reflected from the at least one of the first part and the second part.

16. A semiconductor measuring device comprising:
a light source configured to output light toward a measurement target;
an aperture on a light path along which reflected light from the measurement target travels and comprising a first part and a second part that are spaced apart to form a pinhole;
at least one sensor configured to detect a size of the pinhole; and
a controller connected to the aperture and the at least one sensor, wherein the controller is configured to:
control positions of the first part and the second part so that the pinhole has the size corresponding to a type of the measurement target based on the type of the measurement target; and
determine whether the pinhole has the size corresponding to the type of the measurement target based on data associated with the size of the pinhole acquired from the at least one sensor.

17. The semiconductor measuring device of claim 16, further comprising:
a computing device configured to calculate a thickness of the measurement target based on polarization information about the reflected light passing through the aperture,
wherein the controller is further configured to measure the thickness of the measurement target using the computing device based on the pinhole having the size corresponding to the type of the measurement target.

18. The semiconductor measuring device of claim 17, wherein the controller is further configured to output error data based on the pinhole not having the size corresponding to the type of the measurement target.

19. The semiconductor measuring device of claim 17,
wherein the first part comprises a first surface, and the second part comprises a second surface,
wherein the at least one sensor comprises:
a first sensor between the first surface and the computing device, the first sensor being configured to measure first position data of the first part; and
a second sensor between the second surface and the computing device, the second sensor being configured to measure second position data of the second part, and
wherein the controller is further configured to determine whether the pinhole formed by the first part and the second part has the size corresponding to the type of the measurement target using at least one of the first position data and the second position data.

20. The semiconductor measuring device of claim 17, further comprising:
a polarizer configured to control a polarization direction of the light output from the light source; and
an analyzer configured to acquire the polarization information about the reflected light by acquiring the reflected light reflected from the measurement target.
